(19) United States
(12) Patent Application Publication
(10) Pub. No.: US 2008/0193819 A1
(43) Pub. Date: Aug. 14, 2008

(54) FUEL CELL USING THE CATALYST OF METAL CLUSTERS

(76) Inventors: Yasuo YOSHII, Naka (JP); Hidetoshi Karasawa, Hitachinaka (JP); Kazutoshi Higashiyama, Naka (JP); Hidehiro Iizuka, Mito (JP); Shuichi Kanno, Hitachinaka (JP); Shuichi Suzuki, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/019,937

(22) Filed: Jan. 25, 2008

(30) Foreign Application Priority Data
Feb. 13, 2007 (JP) 2007-031536

(51) Int. Cl. H01M 8/10; H01M 4/94

(52) U.S. Cl. 429/30; 429/40

(57) ABSTRACT

According to the present invention, it is possible to provide a catalyst which includes metal clusters containing a non-platinum element as the catalyst active ingredient, these metal clusters having species of a metal having different valences, and exhibits an improved electrode performance per unit price of the used metal, compared to catalysts using platinum. When this catalyst is applied to an electrode catalyst for fuel cell, a low-cost fuel cell system can be realized without using expensive platinum as the active ingredient. This catalyst can be applied to DMFC and PEFC fuel cells.

### BACKGROUND OF THE INVENTION

1. Field of the Invention

The present invention relates to a metal catalyst for fuel cell, and a fuel cell employing the catalyst.

2. Description of the Related Art

As dispersion type fuel cells for automobiles and general domestic uses, solid polymer type fuel cells (polymer electrolyte fuel cells; hereinafter, abbreviated to PEFC) have been developed. Furthermore, direct methanol fuel cells (hereinafter, abbreviated to DMFC), which use methanol as a fuel, have been developed as the power supply for portable electronic devices. The core of these fuel cells is electrodes, including an anode pole and a cathode pole. In DMFCs, platinum is generally used as the electrode material for the cathode pole, and platinum-ruthenium is used as the electrode material for the anode pole. In PEFCs, platinum is used in both the anode pole and the cathode pole.

As such, platinum is an important constituent material for fuel cells, but platinum is expensive. Thus, it has been investigated in Journal of the Chemical Society of Japan, 1988, (8), p. 1426-1432 (Non-Patent Document 1) as to the possibility of reducing the amount of use of platinum by enhancing the performance of the catalyst.

### SUMMARY OF THE INVENTION

Although the development of a catalyst having a reduced amount of platinum is on the progress as described above, the development of a catalyst surpassing platinum in the performance has not yet been achieved. Therefore, it is an object of the present invention to provide a catalyst for fuel cell which can exhibit satisfactory cell performance without using platinum.

An aspect of the invention to solve the above-described problems lies in a fuel cell using a metal cluster catalyst which is composed of a metal other than platinum, as the active element of electrode catalyst. In particular, the catalyst is a catalyst for fuel cell in which metal clusters have been supported on an electroconductive support, and has species of a metal having different valences within the metal clusters. As for the valence, it is preferable that a species having a valence of zero and a species having a valence of 2 or greater are co-present. For example, it is preferable that the metal clusters contain palladium, and the palladium includes a palladium species having a valence of zero and a palladium species having a valence greater than 2. Also, in this case, it is desirable that the proportion of the palladium atoms having a valence greater than 2 is larger than the proportion of the palladium atoms having a valence of zero.

The catalyst of the present invention can be used in any fuel cell such as PEFC or DMFC, and in any of the anode electrode and the cathode electrode. The metal cluster catalyst described above can be used while being directly supported on an electrolyte membrane. The catalyst of the present invention allows composing an electrode catalyst without using any platinum, or with a reduced amount of platinum. Thus, a catalyst with improved electrode performance per unit price of the metal used, compared to a catalyst using platinum, can be provided, and thus it is possible to reduce the production costs of fuel cells.

Another aspect of the present invention is a portable electronic device or a fuel cell system, equipped with the fuel cell described above.

According to the present invention, there can be provided a catalyst with improved electrode performance per unit price of the metal used, compared to the conventional platinum catalysts for fuel cell. Therefore, when this catalyst is applied to the electrode catalyst of a fuel cell, a fuel cell system can be realized at low production costs.

### BRIEF DESCRIPTION OF THE DRAWINGS

FIG. 1 is a schematic diagram of a PEFC system;

FIG. 2 is a diagram comparing the oxidation reduction potential of various metals;

FIG. 3 is a diagram showing the relationship between the potential and the relative value of oxygen reduction current of a Pd₂₀₆₀ cluster/C1 catalyst;

FIG. 4 is a diagram showing the relationship between the potential and the relative value of oxygen reduction current of Pd₂₀₆o cluster/C1;

FIG. 5 is a diagram showing the result for X-ray diffraction measurement of a Pd₂₀₆₀ cluster/C1 catalyst;

FIG. 6 is a diagram showing the relationship between the ratio of valences and the relative value of specific activity of Pd₂₀₆₀ cluster/C1 catalysts;

FIG. 7 is a diagram showing the relationship between the potential and the relative value of oxygen reduction current of a Pd₄ cluster/C1 catalyst;

FIG. 8 is a diagram showing the relative values of the price of active metal necessary for obtaining an oxygen reduction current of 1 A in various Pd catalysts;

FIG. 9 is a diagram showing the relative values of the price of active metal necessary for obtaining a hydrogen oxidation current of 1 A in various Pd catalysts;

FIG. 10 is a diagram showing the result of observation of a Pd₂₀₆₀ cluster/C1 catalyst under a scanning transmission electron microscope; and

FIG. 11 is a diagram showing the relationship between the ratio of valences and the relative values of specific activity of Pd₂₀₆₀ cluster catalysts.

### DESCRIPTION OF REFERENCE SYMBOLS

1 PEFC fuel cell
2 Reformer
3 CO shift converter
4 CO removal unit
5 Auxiliary combustor
6 Vaporizer
7 Hot water tank
8 Supplementary water heater
9 Steam-water separator
10 Coolant water tank
11 Exhaust gas
12, 15, 18 Air
13 Reforming gas
14 City gas
17 Water

### DESCRIPTION OF THE PREFERRED EMBODIMENTS

Hereinafter, the present invention will be described in detail by way of Examples.

A fuel cell is constituted mainly of an anode electrode for oxidizing fuel, a cathode electrode for reducing oxygen, and an electrolyte membrane for transmitting hydrogen ions, disposed between the two electrodes.

The principle of operation of the fuel cell will be briefly described by taking DMFC as an example. A DMFC includes an anode pole (fuel pole) and a cathode pole (air pole). In the anode pole, as shown in expression (1), methanol as the fuel reacts with water to generate hydrogen ions (hereinafter, abbreviated to H⁺), electrons (hereinafter, abbreviated to e⁻) and CO₂. On the other hand, in the cathode pole, as shown in expression (2), H⁺ which has permeated through an electrolyte membrane reacts with O₂ in the air supplied from the outside to generate water.

### (Expression 1)

Reaction at anode pole: CH₃OH+H₂O→6H+CO₂+6e⁻ (1)

### (Expression 2)

Reaction at cathode pole: 6H⁺+3/2O₂+6e⁻→3H₂O (2)

Electric current can be obtained by connecting the anode pole and the cathode pole with an outer circuit. The catalyst of the present invention is to activate the reactions at the anode pole and the cathode pole.

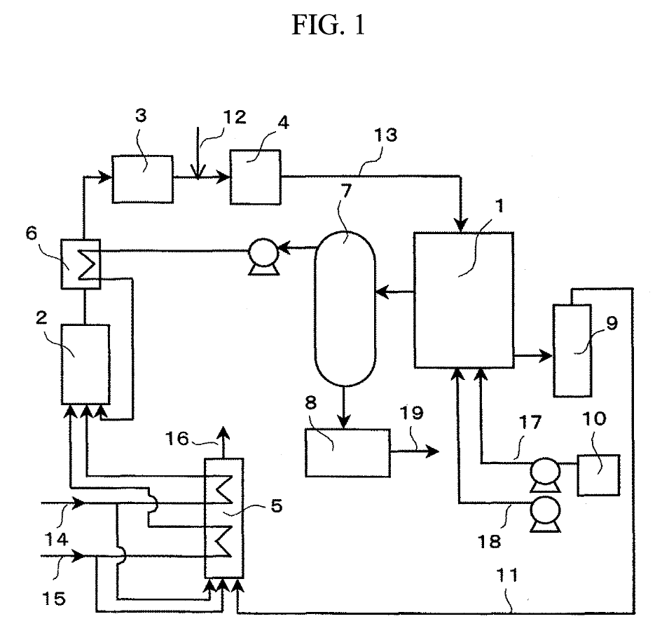

The fuel cell system of the present invention is a system having functions of reforming city gas or the like with hydrogen, generating electricity by supplying the reformed gas to a fuel cell, and supplying hot water by heating water while generating electricity. An outline of a PEFC system will be described in the following. As shown in FIG. 1, a PEFC fuel cell system includes a PEFC fuel cell 1, a reformer 2, a CO shift converter 3 and a CO removal unit 4. The electrode catalyst of the present invention can be employed as an electrode catalyst for anode as well as an electrode catalyst for cathode, which constitute the PEFC fuel cell 1.

In a domestic PEFC system having an auto-thermal type fuel reforming apparatus, city gas 14 as a fuel and air 15 are preheated in an auxiliary combustor 5 and then supplied to the reformer 2. In the reformer 2, a reforming gas 13 containing hydrogen gas is generated under the catalytic action of a reforming catalyst. In the PEFC fuel cell 1, the anode pole is supplied with hydrogen in the reforming gas 13, while the cathode pole is supplied with oxygen in air 18, and thereby electricity is generated. If carbon monoxide is contained in the reforming gas 13, and this adsorbs onto the electrode catalyst in the anode pole, the catalytic activity of the catalyst is decreased. Thus, it is necessary to reduce carbon monoxide in the CO shift converter 3 and the CO removal unit 4, to a level of about 10 ppm or less. In the CO removal unit 4, carbon monoxide is reduced by oxidizing CO over a CO selective combustion catalyst packed in the unit, and thus oxygen required in the oxidation reaction is supplied by air 12.

The PEFC fuel cell 1 is supplied with water 17 from a coolant water tank 10, and hot water heated in the fuel cell is stored in a hot water tank 7. This hot water is further heated by a supplementary water heater 8 for domestic use. Some of the water in the hot water tank 7 is heated in a vaporizer 6, and is supplied to the reformer 2 as steam. An anode exhaust gas 11 discharged from the anode of the PEFC fuel cell 1 is separated into gas and liquid in a steam-water separator 9, and the gas portion is introduced into the auxiliary combustor 5 so that the uncombusted fraction is combusted.

The catalyst for fuel cell of the present invention is characterized in using metal clusters which have metal atoms with different valences. A metal cluster is defined as a molecule in which a group consisting of three or more metal atoms bound by metallic bonding is surrounded by ligands. The metal cluster is a family of unique compounds which is intermediate between bulk metal (simple metal substance) and metal complex. A supposed reaction mechanism occurring at the cathode of a fuel cell will be explained. Initially, Pd⁰ in the catalyst palladium clusters adsorbs the hydrogen ions present in the electrolyte. Then, oxidized metal ions of Pd²⁺ or higher, which are present adjacently to these adsorption sites, react with the adsorbed hydrogen to generate H₂O. At lattice defect of oxygen formed by the leaving of oxygen, oxygen in the air supplied to the cathode pole is received, and forms the adsorption sites for hydrogen ions again. As the reaction path described above is repeated, the oxidation reaction represented by the equation (2) can be sustained.

As for the valence, it is preferable that a valence of zero and a valence of 2 or greater co-exist. In particular, it is preferable that the number of moles of a metal ion having a valence of 2 or greater is larger than the number of moles of metal having a valence of zero, and particularly in palladium, it is preferable that the ratio of the number of moles of tetravalent palladium and the number of moles of zero-valent palladium is 0.38 or greater. It is preferable that the proportion in the number of moles of a zero-valent metal species is in the range of 20 to 50%, the proportion of a divalent metal species is in the range of 20 to 50%, and the proportion of a tetravalent metal species is in the range of 10 to 50%.

The particle size of the metal cluster is preferably 160 Å or less. Particularly in the case of palladium cluster, the particle size is preferably in the range of 40 Å to 160 Å.

As for the metal cluster, any one selected from gold, tungsten, copper, cobalt, nickel, iron, manganese, palladium, rhenium, male aluminium, iridium, rhodium, ruthenium and platinum may be considered as the metal component. It is particularly preferable to use palladium. Among noble metals, platinum has the highest activity of simple metal substance, and rhodium and palladium follow platinum in the order of higher activity. Meanwhile, the reverse applies in terms of the price. Therefore, palladium is a metal of the lower price, while having a potential for increasing the activity. The content of palladium in the catalyst is preferably in the range of 5% by weight to 50% by weight.

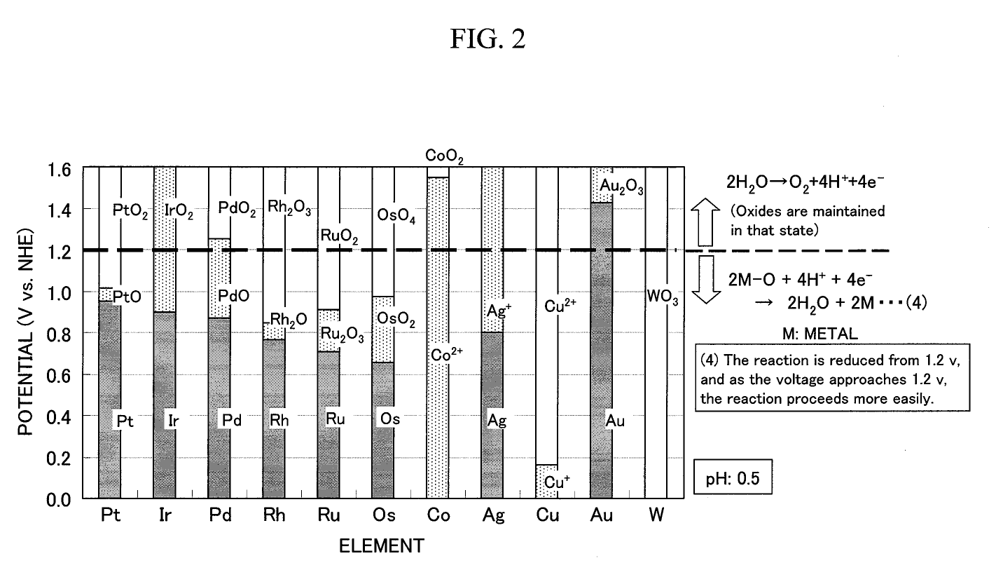

FIG. 2 shows the oxidation reduction potential of various metals. The potential at which the metal oxidation number changes, as shown on the vertical axis, was determined from Pourbaix diagrams. At 1.2 V, the redox reaction of water as represented by expression (3) reaches equilibrium.

### (Expression 3)

2H₂O⇄O₂+4H⁺+4e⁻ (3)

wherein, at 1.2 V or lower, the oxygen reduction reaction represented by the expression (3) proceeds, and the reaction proceeds from the left-hand side to the right-hand side. The oxygen involved herein to react with hydrogen ions is the oxygen released from the reduction of the oxide of the catalyst metal. For example, with a Pt catalyst, the oxygen released from PtO according to the expression (2) reacts with the hydrogen ions from the expression (3) to generate H₂O.

### (Expression 4)

2Pt—O+4H⁺+4e⁻→2H₂O+2Pt (4)

Assuming that the oxygen released from metal oxide is involved, as the potential at which the oxidation state of a metal changes approaches 1.2 V as closely as possible, it becomes easier for the reaction of releasing oxygen as shown by the expression (4) to proceed. In FIG. 2, the potential for Ir at which the oxidation state changes from IrO₂ to Ir is 0.9 V, and the potential for Pd at which the oxidation state changes from PdO to Pd is 0.87 V. When the same evaluation is applied to other metals, the order of activity is anticipated to be as shown in expression (5).

### (Expression 5)

Pt>Ir>Pd>Rh>Ru>Os (5)

According to FIG. 2, since Co, Ag and Cu ionize at 1.2 V or lower, they are prone to liquate out and are therefore inadequate as catalysts. However, in the present invention, since the catalyst is in the form of clusters, and ligands are bound to metal ions, the metals are stabilized. Furthermore, for Pd in FIG. 2, the boundary between PdO₂ and PdO is near about 1.25 V, which value is slightly higher than 1.2 V. However, if this boundary is lowered than 1.2 V under a certain action, the oxygen released from the reaction of PdO₂→PdO+½ O₂ oxidizes hydrogen ions to generate H₂O. Therefore, it can be expected that Pd catalysts attain higher performance than Pt catalysts.

Metal clusters are preferably used in a state of being directly supported on the electrolyte membrane. Typically, metal clusters are supported on carbon supports for the purpose of increasing the quantity of catalyst active site, that is, the surface area. However, because using a carbon support results in thickening of the electrode catalyst, the electric resistance increases. Also, gas diffusion is deteriorated, and thus the electrode reactions are impeded. Since the present invention uses metal clusters, which have high activity even without being dispersed on a support, there is no need to use any support.

The metal cluster catalyst preferably has an electrical quantity per unit weight of metal in the metal clusters, of 18 coulomb or larger. This electrical quantity is determined by measuring the hydrogen desorption wave by cyclic voltammetry, and calculating from the result.

### (Expression 6)

Catalyst adsorption site —H→H⁺+e⁻ (6)

As shown in expression (6), the hydrogen adsorbed onto the catalyst active sites are converted to hydrogen ions and releases electrons. The electrical quantity at this time can be quantified by measuring the current changing with the changes in the potential, and determining from the area under peak of the hydrogen desorption wave obtained from the current measurement.

### EXAMPLE 1

In the current Example, a production method for a catalyst having Pd clusters supported on an electroconductive carbon support will be described.

(Method for Synthesis of Pd Clusters)

Synthesis of Pd clusters was performed with reference to the method of Kaneda et al. (Langmuir, 2002, p. 1849-1855). This preparation method involves synthesizing two types of Pd₄ clusters, and finally synthesizing Pd₂₀₆₀(NO₃)₃₆₀(CH₃COO)₃₆₀O₈₀ clusters.

0.93 g of acetic acid palladium and 92.7 cc of acetic acid were introduced into a flask, and this flask was placed in an oil bath. The content of the flask was heated to 50° C. while stirring. This solution was subjected to bubbling of 10% —CO/N₂ gas using a glass pipette as a nozzle. The flow rate of the gas was 500 cc/mini and the aeration time was 6 hours. Aeration of CO for a predetermined time resulted in the generation of a yellow precipitate on the flask bottom. The remaining acetic acid was decanted such that the yellow precipitate would not be mistakenly discarded with acetic acid, and then the residual acetic acid was exhausted in a vacuum. Vacuum exhaustion was continued further for 30 minutes from the time point where there was no acetic acid remaining behind, and thereby a dried yellow precipitate was obtained. The yellow precipitate was Pd₄(CO)₄(CH₃COO)₄.2CH₃COOH (abbreviated to PCA) cluster.

0.556 g of PCA, 0.249 g of 1,10-phenanthroline monohydrate and 10 cc of acetic acid were introduced in a two-necked flask, and the mixture was stirred for 30 minutes at room temperature and at atmospheric pressure, thus to obtain Pd₄(C₁₂H₈N₂)₂(CO)₂(CH₃COO)₄ clusters as a precipitate.

0.015 g of Cu(NO₃)₂.3H₂O was added to the flask, and then the flask was subjected to a vacuum. O₂ gas was supplied to the flask from a tetra back equipped with a syringe needle. The flask under an oxygen atmosphere was placed in an oil bath, and the content was stirred for 25 minutes at 90° C., to obtain Pd₂₀₆₀(NO₃)₃₆₀(CH₃COO)₃₆₀O₈₀ clusters as a black precipitate.

(Method for Supporting Pd₂₀₆₀ on Carbon Support)

A carbon support and the Pd₂₀₆₀(NO₃)₃₆₀(CH₃COO)₃₆₀O₈₀ clusters were introduced into a Schlenk tube, and acetic acid was added thereto. The amount of addition of the Pd₂₀₆₀(NO₃)₃₆₀(CH₃COO)₃₆₀O₈₀ clusters was adjusted such that the support rate for Pd would be 15.3% by weight. The carbon support used herein was an electroconductive carbon black support (hereinafter, C1). The resulting mixture was stirred for 3 hours at 60° C. After the stirring, acetic acid was evaporated by subjecting the Schlenk tube to a vacuum. While stirring, the content of the Schlenk tube was heated under a vacuum for 2 hours at 185° C., to fix the Pd₂₀₆₀(NO₃)₃₆₀(CH₃COO)₃₆₀O₈₀ clusters, and thereby a catalyst having the Pd₂₀₆₀(NO₃)₃₆₀(CH₃COO)₃₆₀O₈₀ clusters supported on a carbon black support (hereinafter, Pd₂₀₆₀ cluster/C1) was produced.

In addition, the fixing process may be performed by an exhaustion treatment at 25° C. instead of a heat treatment.

(Method for Supporting Pd₄ on Carbon Support)

Pd₄(C₁₂H₈N₂)₂(CO)₂(CH₃COO)₄ clusters were supported on a carbon support by the same method, and thus a catalyst having the Pd₄(C₁₂H₈N₂)₂(CO)₂(CH₃COO)₄ clusters supported on a carbon black support (hereinafter, Pd₄ cluster/C1) was produced.

The amount of addition of the Pd₄(C₁₂H₈N₂)₂(CO)₂(CH₃COO)₄ clusters was adjusted such that the support rate for Pd would be 15.3% by weight.

### EXAMPLE 2

Next, the catalyst performance of the Pd clusters prepared in Example 1 was compared with the performance of commercially available Pt catalyst and Pd catalyst.

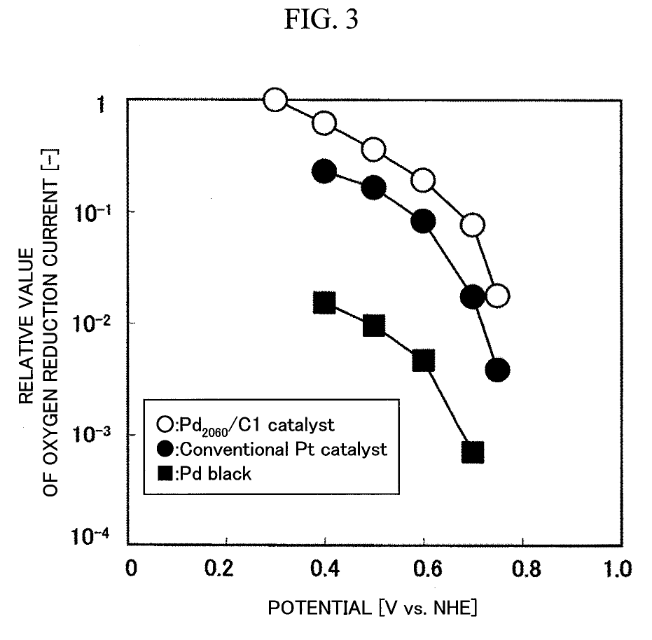

FIG. 3 shows the results of an evaluation of the Pd₂₀₆₀ cluster/C1 catalyst prepared in Example 1, a currently commercially available Pt catalyst and a commercially available Pd black catalyst for the oxygen reduction activity, which serves as an index for the performance of an electrode catalyst for cathode. The Pt catalyst is composed of 50% of platinum metal, and carbon black for the balance. The Pd catalyst contains 99.8% or more of palladium metal.

The method for measuring the oxygen reduction activity of the produced electrode catalyst will be described in the following. The oxygen reduction activity was measured by a rotating disk electrode method. This technique is characterized in that the activity can be evaluated while excluding the influence of diffusion, by making use of the fact that the amount of supplied reactant materials is directly proportional to the one-half power of the rotation rate ω (rad/s) of a disk electrode. The electrolyte used was a H₂SO₄ solution, and O₂ bubbling was carried out for 1 hour or longer before measurement. The measurement temperature was 35° C. The measurement of the oxygen reduction activity was performed at a sweeping rate of 10 mV/s and a sweeping range of 0.2 to 1.1 V versus NHE. During the measurement of the oxygen reduction activity, the disk electrode of the operating electrode was rotated at various rotation speeds. The rotation speeds were 400, 625, 900, 1600 and 2500 rpm. The reduction current for oxygen increases as the rotation speed increases, because the supply amount of reactant materials increases. The relationship between the reciprocal of the current value I (mA) and the minus one-half power of the rotation rate ω (rad/s) of the electrode at a measured value of 0.7 V versus NHE is expressed by the Levich-Koutecky plot represented by expression (7).

### (Expression 7)

1/i=1/iₖ+1/(0.320n·F·A·c.D^{2/3}·v^{-1/6})·1/ω^{1/2} (7)

wherein i_{K} is true kinetic current density (mA); n is the number of reacting electrons; F is the Faraday constant (C/mol); A is the geometrical area of the disk electrode (cm²); c is the concentration of reactant in the electrolyte (mol/ml); D is the diffusion coefficient of the reactant (cm²/s); v is the kinematic viscosity of the electrolyte (cm²/s), while the relationship between the rotation speed of the electrode f (rpm) and the rotation rate ω (rad/s) is ω=2πf/60. In the expression (7), the reciprocal of i_{K} can be determined from the segment of ω^{-1/2}=0 (ω=∞, that is, the supply amount of reactant is infinite). Therefore, the obtained i_{K} corresponds to the net activity of the catalyst which is not affected by the diffusion of reactants. The oxygen reduction current i_{R}, which is the performance of the air pole, was determined from expression (8).

### (Expression 8)

i_{R}=iₖ/W_{M} (8)

wherein W_{M} is the weight (mg) of active metal in the evaluated catalyst.

The horizontal axis indicates the potential, while the vertical axis indicates the relative value of oxygen reduction current. At the same potential, as the relative value of oxygen reduction current increases, the performance of cathode electrode catalyst also increases. When the oxygen reduction current value of a Pd₂₀₆₀ cluster/C1 catalyst at 0.3 V was set at 1.0, the performance of the Pd₂₀₆₀ cluster/C1 catalyst was higher than that of a conventional Pt catalyst. The performance of the former was, for example, 2.7 times the value of the latter at 0.4 V, 2.2 times at 0.5 V, 2.3 times at 0.6 V, and 4.4 times at 0.7 V.

### EXAMPLE 3

Next, the difference in catalyst performance as a result of the production method for Pd clusters was examined.

The Pd₂₀₆₀ cluster/C1 prepared in Example 1 (the vacuum heat treatment temperature was set at 185° C., and the clusters were supported on a support), and Pd₂₀₆₀ cluster/C1 prepared by an exhaustion treatment at 25° C. instead of a heat treatment at 185° C., were prepared. For the two types of Pd₂₀₆₀ clusters, the performance of the electrode catalyst for cathode was evaluated on the basis of the oxygen reduction activity.

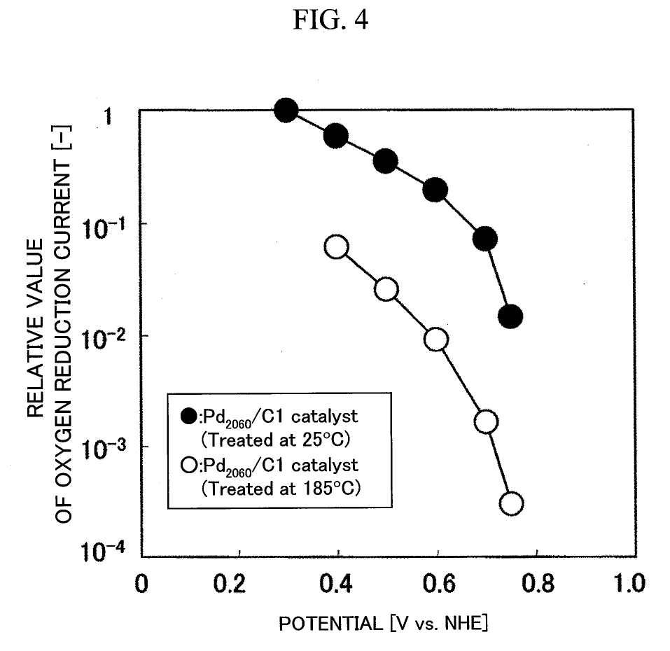

In FIG. 4, the horizontal axis indicates the potential, while the vertical axis indicates the relative value of oxygen reduction current. The oxygen reduction current value at 0.3 V of the Pd₂₀₆₀ cluster/C1 treated at 25° C. was set at 1.0. The oxygen reduction current value of the Pd₂₀₆₀ cluster/C1 catalyst produced at a vacuum heat treatment temperature of 25° C., was higher than that of the Pd₂₀₆₀ cluster/C1 catalyst produced at a vacuum heat treatment temperature of 185° C., and the value of the former was 10 times the value of the latter at 0.4 V, 14 times at 0.5 V, 22 times at 0.6 V, and 44 times at 0.7 V. Therefore, the cathode electrode catalyst performance of the Pd₂₀₆₀ cluster/C1 catalyst produced at a vacuum heat treatment temperature at 25° C. was higher than that of the Pd₂₀₆₀ cluster/C1 catalyst prepared by a heat treatment at 185° C. Thus, there is a possibility that the catalyst performance can be improved by optimizing the preparation conditions. Furthermore, it is preferable to perform the conditions for Pd cluster conditioning at about room temperature (20 to 40° C.).

### EXAMPLE 4

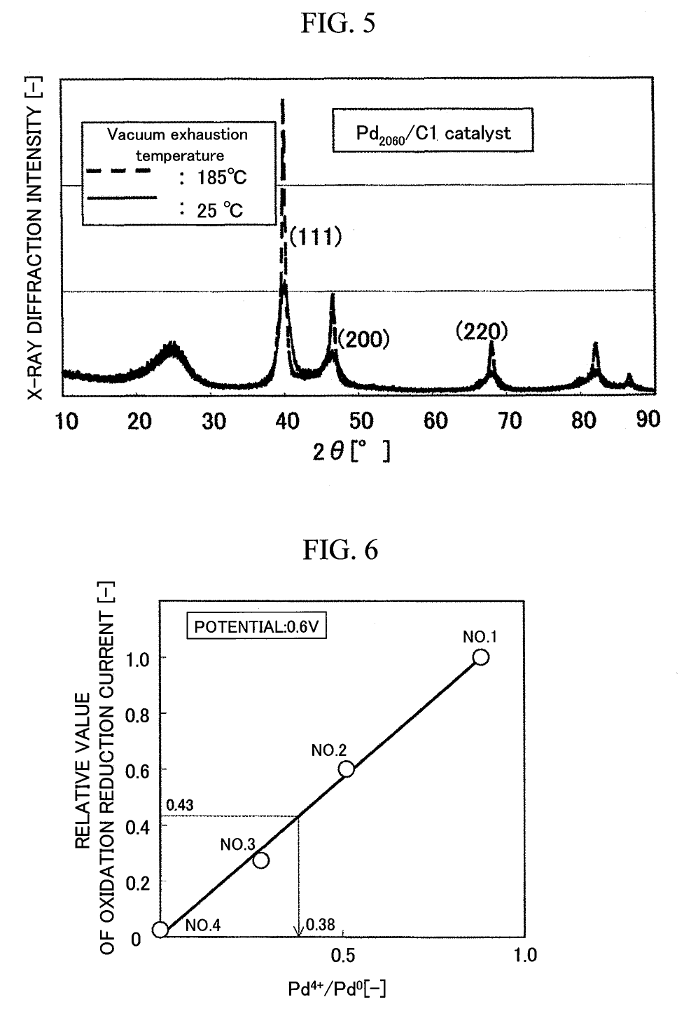

The difference in the catalyst structure as a result of the differences in the preparation conditions was examined. FIG. 5 shows the results for the X-ray diffraction analysis of a Pd₂₀₆₀ cluster/C1 catalyst. The full width at half-maximum of the diffraction peak corresponding to the (111) plane of metal Pd, and the Bragg angle of the diffraction line were substituted into the Scherar equation to determine the crystallite diameter.

### (Expression 9)

D=K·λ/βcosθ (9)

wherein D is the crystallite diameter (Å); λ is the wavelength of measured X-ray; β is the full width at half-maximum (rad); θ is Bragg angel (rad) of the diffraction line; and K is a constant ((in the case of full width at half-maximum, K=0.9).

While the crystallite diameter of the catalyst produced by an exhaustion treatment at 185° C. was 170 Å, the crystallite diameter of the catalyst produced by an exhaustion treatment at 25° C. was 56 Å. Thus, it was found that a size reduction to a level of one-third or less had occurred in the crystallites.

As can be seen from the results of Example 3, the catalytic activity was higher in the catalyst produced at a vacuum heat treatment temperature of 25° C. than in the catalyst produced at 185° C., and the reason is suspected to be because the Pd particles in the catalyst were micronized, and therefore the surface area increased.

### EXAMPLE 5

A Pd₂₀₆₀ cluster/C1 catalyst includes palladium species having a plurality of valences. The relationship between the valence of metal and the catalytic activity was examined. FIG. 6 shows a graph concerning 4 types of palladium catalysts, such as three types of Pd₂₀₆₀ cluster/C1 catalysts (No. 1 to No. 3) and a commercially available Pd black catalyst (No. 4), in which graph the horizontal axis indicates the ratio of the proportion of the number of moles of Pd⁴⁺ and the proportion of the number of moles of Pd⁰, as determined from the X-ray photoelectron spectroscopy (XPS) measurement, and the vertical axis indicates the relative value of oxygen reduction current. The relative value of oxygen reduction current (specific activity) of No. 1 catalyst was taken as 1.0. The potential was 0.6 V.

The analytic instrument used in the analysis was Model AXIS-HS manufactured by Shimadzu-KRATOS Co., Ltd. For the measurement conditions, the X-ray source was monochromatic Al (tube voltage: 15 kV, tube current: 15 mA), a hybrid lens was used (analyzed area: 600×1000 μm²), the resolution was Pass Energy 40, and the scanning speed was 20 eV/min (in step of 0.1 eV).

Catalysts No. 1 to No. 3 were produced by the production method described in Example 1, while appropriately varying the molar ratio of Cu(NO₃)₂.3H₂O and PCA. The molar ratio of Cu(NO₃)₂.3H₂O and PCA for No. 1 and No. 2 was 0.10, and the molar ratio of Cu(NO₃)₂.3H₂O and PCA for No. 3 was 0.15. Catalyst No. 4 was a commercially available Pd black catalyst, which contained 99.8% or more of palladium metal.

As the ratio of the proportion of the number of moles of Pd⁴⁺ and the proportion of the number of moles of Pd₀ increased, that is, as the amount of tetravalent Pd increased relative to the amount of zero-valent Pd, the oxygen reduction current increased. Therefore, it is conceived that when a catalyst is prepared such that the ratio of the proportion of the number of moles of Pd⁴⁺ and the proportion of the number of moles of Pd⁰ increases, the catalyst performance can be enhanced.

In addition, the relative value of oxygen reduction current of the conventional platinum catalyst is 0.43, as shown in the drawing. Thus, by rendering the proportion of the number of moles of Pd⁴⁺ and the number of moles of Pd⁰ to be 0.38 or greater, a catalyst having a performance superior to that of a platinum catalyst can be prepared.

### EXAMPLE 6

Furthermore, the ratio of Pd ions with various valences was investigated for various catalysts. Table 1 shows the ratios of the number of moles of Pd ions in various catalysts. The ratio of valences for the various palladium species were determined by X-ray photoelectron spectroscopy measurement (XPS). In XPS, the valence was identified from the energy shift of each peak, and the ratio of the number of moles of each palladium ion species was quantified from the area ratio of the peaks corresponding to the respective valences. The results of determining, by XPS analysis, the proportions of the number of moles of palladium metal valences in the catalysts used in the test, are shown in Table 1.

TABLE 1

| | | | | | Performance ratio |
|---|---|---|---|---|---|
| Catalyst | Pd⁰[%] | Pd²⁺[%] | Pd⁴⁺[%] | Pd⁴⁺/Pd⁰ | (mA/mg) |
| NO. 1 | 34 | 36 | 30 | 0.882 | 1.000 |
| NO. 2 | 43 | 35 | 22 | 0.512 | 0.601 |
| NO. 3 | 47 | 40 | 13 | 0.277 | 0.274 |
| NO. 4 | 37 | 63 | 0 | 0.000 | 0.025 |

The catalyst No. 1 (Pd₂₀₆₀ cluster/C1 catalyst) having the highest performance contained 34% of Pd⁰ and 30% of Pd⁴⁺. The catalyst No. 4 (Pd black catalyst) had low performance as clearly shown in FIG. 6. Although the catalyst No. 4 contained 37% of Pd⁰, Pd⁴⁺ was not contained. Pd⁰ is believed to provide adsorption sites for H⁺, and it is also believed that Pd⁴⁺ forms PdO₂ and oxidizes the H⁺ adsorbed onto Pd⁰. Thus, the presence of both palladium species in the catalyst is necessary for obtaining high oxygen reduction performance.

As can be seen from the above-described results, the catalyst No. 4 contains almost the same amount of Pd⁰ as that contained in the catalyst No. 1. On the other hand, these catalysts have largely different amounts of Pd⁴⁺. Thus, it is conceived that as the amount of tetravalent palladium increases, the catalytic activity is enhanced. The catalysts No. 1 to No. 3 contained 34 to 47% of Pd⁰, 36 to 40% of Pd²⁺, and 13 to 30% of Pd⁴⁺, and showed high catalytic activity. Therefore, in the case where zero-valent, divalent and tetravalent metal ions co-exist, the proportions of the zero-valent and divalent species are preferably 20 to 50%, respectively, and the proportion of the tetravalent species is preferably 10 to 50%.

A suspected reaction mechanism of the palladium cluster catalyst at the cathode of a fuel cell is conceived to be as follows. Initially, Pd⁰ in the palladium clusters adsorbs hydrogen ions in the electrolyte. Then, oxidized metal ions of Pd²⁺ or higher which are present adjacently to these adsorption sites, react with the adsorbed hydrogen to generate H₂O. At lattice defect of oxygen formed by the leaving of oxygen, oxygen in the air which is supplied to the cathode pole, is received, and forms the adsorption sites for hydrogen ions again. As the reaction path described above is repeated, the oxidation reaction represented by the equation (2) can be sustained.

### EXAMPLE 7

The catalyst performance depends on the quantity of the catalyst active site (surface area) and the quality of the catalyst active site (performance per unit surface area). As the catalyst surface area increases, there occur more sites for activating the reaction, and thus the performance is improved. In the current Example, the surface area of a catalyst active site required for exhibiting higher performance was examined.

The electric quantity per unit weight of active metal, which corresponds to the area of the H desorption peak measured for a catalyst, serves as an index representing the size of the surface area per unit weight of active metal. The electric quantities per unit weight of active metal, which correspond to the areas of the H desorption peak measured for various catalysts by cyclic voltammetry, are presented in Table 2. The unit “c” is used for the electric quantity determined from the area of the H desorption peak by cyclic voltammetry (the electric quantity becomes larger as the surface area of the active site increases). Therefore, c/g is an index representing the size of the surface area per unit weight of the catalyst.

TABLE 2

| | | Performance ratio |
|---|---|---|
| Catalyst | Surface area (c/g) | (mA/mg) |
| NO. 1 | 22.4 | 1.000 |
| NO. 2 | 17.4 | 0.601 |
| NO. 3 | 17.9 | 0.274 |
| NO. 4 | 17.7 | 0.025 |

The surface areas of the catalysts No. 2 to No. 4 are as small as 17.4 to 17.9 c/g, while the surface area of the catalyst No. 1 is as large as 22.4 c/g. Thus, when the surface area is made as large as 18 c/g or more, a catalyst having higher performance can be provided.

### EXAMPLE 8

Next, the performance of Pd₄ clusters will be described.

The Pd₄ cluster/C1 catalyst prepared by the method of Example 1, a currently commercially available Pt catalyst, and a Pd black catalyst were compared for the catalytic activity. The Pt catalyst contained 50% of platinum metal, and carbon black for the balance. The vacuum heat treatment temperature of the Pd₄ cluster/C1 catalyst was 185° C.

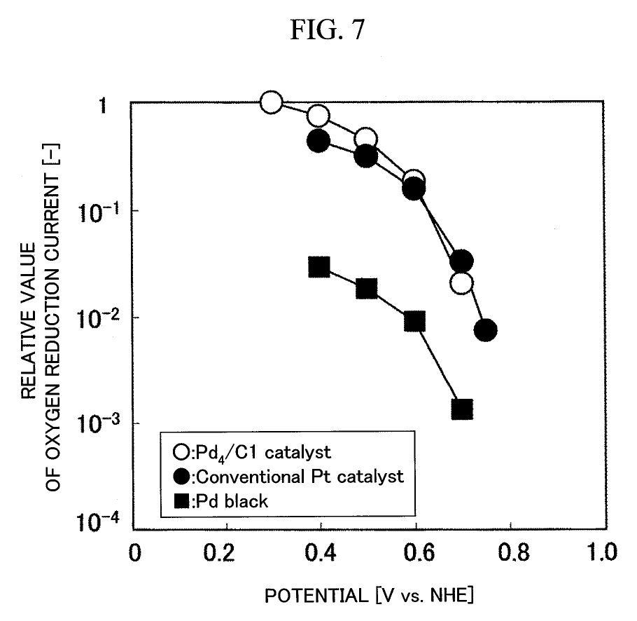

In FIG. 7, the horizontal axis indicates the potential, while the vertical axis indicates the relative value of oxygen reduction current of various catalysts. The oxygen reduction current value of the Pd₄ cluster/C1 catalyst at 0.3 V was taken as 1.0. The performance of the Pd₄ cluster/C1 catalyst was higher than that of the conventional Pt catalyst, and for example, the performance of the Pd₄ cluster/C1 catalyst was 1.7 times the performance of the Pt catalyst at 0.4 V, about 1.4 times at 0.5 V, and 1.2 times at 0.6 V. Therefore, the performance of the Pd₄ cluster electrode catalyst prepared by the production method of the present invention is higher than that of a Pt catalyst.

### EXAMPLE 9

Next, the prices per performance for various catalysts were compared. Although the metal price fluctuates, the price of Pt in around July of year 2006 was 4445 (¥/g), and the price of Pd of then was 1160 (¥/g).

The price of an active metal required for obtaining an oxygen reduction current of 1 A (¥/A) was determined from expression (10).

Price of active metal required for obtaining oxygen reduction current of 1 A (¥/A)=C/i_{R} (10) (wherein i_{R} is the oxidation reduction current generated per unit weight of catalyst (A/g); and C is the price per unit weight of the catalyst (¥/g)).

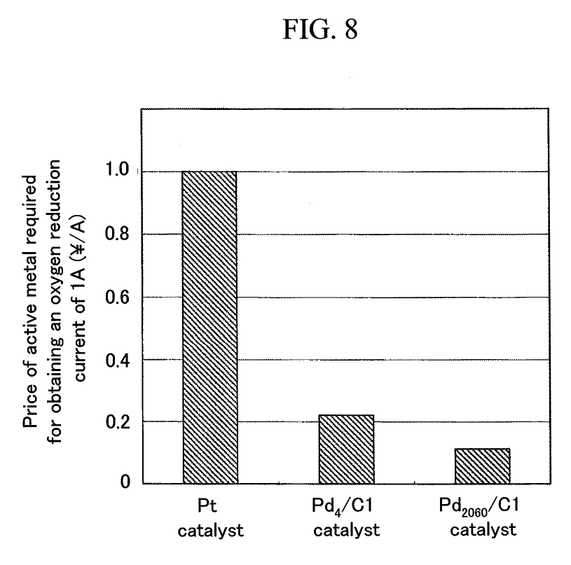

FIG. 8 shows the relative values of the price of active metal required for obtaining an oxygen reduction current of 1 A (¥/A). The price of the Pt catalyst was taken as 1. The price of the Pd₄/C1 catalyst is about 1/4, and the price of the Pd₂₀₆₀/C1 catalyst is about 1/9, of the price of the platinum bulk catalyst which is being used as a material for electrode catalysts. Accordingly, when the catalyst of the present invention is used, the cost of electrode material can be cut down by a large extent.

Furthermore, the amount of supported platinum in a conventional platinum catalyst is 50% by weight. As can be seen from the results of FIG. 8, since the cost performance of palladium is about 10 times that of platinum, in order to manifest a performance equivalent to that of a platinum catalyst, a palladium catalyst can have a support ratio reduced to 1/10 of the support ratio of the platinum catalyst, which corresponds to 5% by weight. The support ratio may be chosen to be larger than this value, in consideration of catalyst lifespan. Therefore, in the case of using a palladium cluster catalyst, it is preferable to set the content of palladium to the range of 5% by weight to 50% by weight.

TABLE 3

| | | | Hydrogen |
|---|---|---|---|
| | | Current density | oxidation current |
| | | [mA/cm²] | [mA/mg] |
| Conventional | Pt catalyst | 480 | 1200 |
| Present | Pd₂₀₆₀/C1 catalyst | 250 | 1250 |
| invention | Pd₂₀₆₀/C2 catalyst | 297 | 1100 |

The performance results obtained in the case of applying the catalyst of the present invention to the anode pole of a PEFC fuel cell, are presented in Table 3. Since the weight of noble metal per unit area of electrode varies in the respective cases, the performance per unit weight was evaluated so as to correctly compare the cell performance under the same conditions, and the results are shown in Table 3. C1 is a commercially available Vulcan XC-72R support, and C2 is a Ketjenblack support. The performance of the Pd₂₀₆₀/C1 catalyst was equivalent to that of the Pt catalyst, while the performance of the Pd₂₀₆₀/C2 catalyst was about 90% of that of the Pt catalyst. As such, the Pd catalyst of the present invention can be applied to cathode catalysts, as well as to anode catalysts.

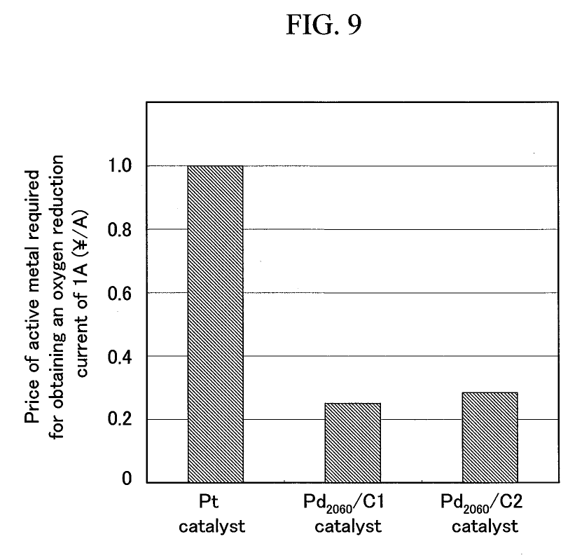

FIG. 9 shows the relative values of the price of active metal required for obtaining a hydrogen oxidation current of 1 A (¥/A). The price of the Pt catalyst was taken as 1. The price reduction can be achieved to about 1/4 in the case of the Pd₂₀₆₀/C1 catalyst, and to 1/3.5 in the case of the Pd₂₀₆₀/C2 catalyst, relative to the platinum bulk catalyst currently used as a material for electrode catalysts. Therefore, the catalyst of the present invention can be applied to the anode material of PEFC, and the material cost can be reduced as compared to that of the Pt catalyst.

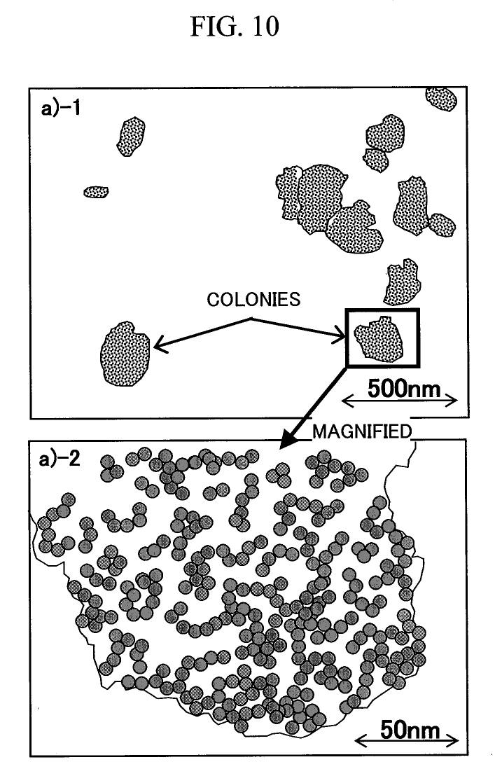

The Pd₂₀₆₀/C1 catalyst was observed under a scanning transmission electron microscope (STEM). FIG. 10 shows the dispersion state of Pd particles found from the observation result at a magnification of 70,000 times. As can be seen from FIG. 10a)-1, it was observed that a large number of colonies of Pd particles (secondary particles) existed. The size of the colonies was approximately from 50 nm to 500 nm. Colonies having a size of about 3,000 Å were largely seen. Furthermore, FIG. 10a)-2 is a diagram showing the observation result at a magnification of 600,000 times. From the result, it was judged that the colonies were aggregates of particles having a size of 50 Å or less which were conceived to be Pd clusters (primary particles). Even in other observations, colonies were observed as in the case of a)-2.

The catalyst of the present Example is not likely to deteriorate. In the case where Pd particles have formed colonies as described above, it is suspected that the interior can hardly be brought into contact with a reactant gas, particularly with oxygen in air, and thus Pd which is the active site, is not likely to undergo oxidation, thereby the performance being possibly maintained. The Pd clusters exiting inside the colonies are protected from the oxygen atmosphere. During the operation of the cell, oxygen in the air as a reactant gas reacts only with the Pd clusters on the surface of the colonies, and there exist more of unreacted Pd particles in the inside. Therefore, Pd⁰ required in the reaction remains behind at a high proportion for a long time, and thus high cell performance can be maintained sustainedly. That is, by using a catalyst such as that of the current Example, the lifespan of the catalyst can be extended, and a highly reliable catalyst can be obtained.

In addition, in the case of producing Pd clusters using acetic acid according to the production method described in Example 1, the particle size range of the secondary particles of the Pd clusters is from 500 to 5,000 Å. In this regard, when an amine-based solvent is used, colonies constituted of secondary particles were not formed, because the dispersibility of Pd particles formed from the clusters becomes enhanced.

The particle size of the carbon support is approximately in the range of 200 to 1,000 Å. It is believed that the Pd clusters form secondary particles, and the carbon support enhances the dispersibility of the catalyst which have not formed colonies. Also, a solid polymer type fuel cell uses an assembly of a positive pole and a negative pole bonded on the opposing sides of an electrolyte membrane (MEA; membrane electrode assembly). The metal clusters of the present Example can be supported on the electrolyte membrane and can be used as an MEA. During the production of electrodes, mixing of carbon support particles makes it easier for the catalyst to be supported on the electrolyte membrane, and thus production of electrodes is made easier, which is preferable.

Furthermore, although the above-described Examples discuss Pd catalysts, Ir, Ru and Os can also be used to prepare metal clusters containing atoms having different valences, in the same manner as in Pd catalysts. Thus, these metals also have potential to be used to prepare the clusters of the present invention.

### EXAMPLE 10

Next, a catalyst having improved dispersibility was produced by making the colonies of the catalyst smaller. In order to improve the dispersibility of a catalyst, it is effective to incorporate a dispersant or to change the solvent during the production.

The method of producing a catalyst with high dispersibility is as follows. A carbon support and Pd₂₀₆₀(NO₃)₃₆₀(CH₃COO)₃₆₀O₈₀ clusters were introduced into a Schlenk tube, and an organic solvent containing a nitrogen atom or a sulfur atom, such as pyridine or dimethylsulfoxide, was added thereto. These solvents have high polarity and can enhance the dispersibility of clusters. The amount of addition of the Pd₂₀₆₀(NO₃)₃₆₀(CH₃COO)₃₆₀O₈₀ clusters was adjusted such that the Pd support ratio would be 43.7% by weight. The carbon support used herein was an electroconductive carbon black support (hereinafter, C1). This mixture was stirred for 1 hour at room temperature. After the stirring, the mixture was filtered to separate the solvent and the catalyst. The catalyst was dried by air at room temperature for one whole day, and thus a catalyst having Pd₂₀₆₀(NO₃)₃₆₀(CH₃COO)₃₆₀O₈₀ clusters supported on a carbon black support (hereinafter, Pd₂₀₆₀ cluster/C1) was prepared.

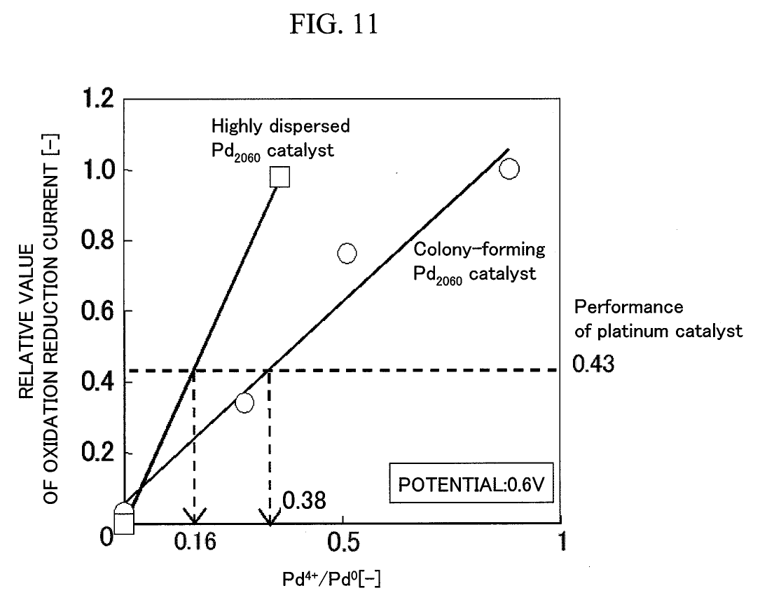

FIG. 11 shows the relationship between the molar ratio of the number of moles of tetravalent palladium and the number of moles of zero-valent palladium (Pd⁴⁺/Pd⁰⁺), and the relative value of the oxidation reduction current which indicates the extent of the activity per unit surface area (relative value of specific activity) for the catalyst with highly dispersed Pd particles of the present Example. As shown in FIG. 11 with a symbol of □, the highly dispersed catalyst of the present Example exhibited a maximum specific activity of 12.8 when the molar ratio of Pd (tetravalent)/Pd (zero-valent) was 0.357. This catalyst shows higher activity than a catalyst prepared by forming colonies, at the same value of Pd⁴⁺/Pd⁰⁺. Also, when the molar ratio Pd⁴⁺/Pd⁰⁺ became 0.16 or greater, the catalyst had a performance superior to that of conventional platinum catalysts.

Therefore, it is possible to provide a catalyst with even higher performance, by increasing the dispersibility of the palladium cluster catalyst, and thereby increasing the ratio of primary particles.

What is claimed is:

1. A fuel cell comprising an anode electrode for oxidizing fuel, a cathode electrode for reducing oxygen, an electrolyte membrane for transmitting hydrogen ions, the electrolyte membrane being disposed between the two electrodes, and an electrode catalyst used in at least any one of said anode electrode and said cathode electrode,
wherein said electrode catalyst has metal clusters and an electroconductive support for supporting said metal clusters, and said metal clusters contain species of a metal having different valences.

2. The fuel cell according to claim 1, wherein said metal clusters comprise a metal species having a valence of zero, and a metal species having a valence of 2 or greater.

3. The fuel cell according to claim 1, wherein said metal clusters comprise palladium, and the palladium includes a palladium species having a valence of zero and a palladium species having a valence of 2 or greater.

4. The fuel cell according to claim 2, wherein the number of moles of the metal species having a valence of 2 or greater is larger than the number of moles of the metal species having a valence of zero.

5. The fuel cell according to claim 3, wherein the palladium includes a palladium species having a valence of 4, and the value obtained by dividing the number of moles of a palladium species having a valence of 4 by the number of moles of a palladium species having a valence of zero is 0.38 or greater.

6. The fuel cell according to claim 5, wherein the ratio of the number of moles of a palladium species having a valence of 4 to the number of moles of a palladium species having a valence of zero (Pd⁴⁺/Pd⁰⁺) is 0.16 or greater.

7. The fuel cell according to claim 1, wherein the metal clusters comprise metal ions having valences of zero, 2 and 4, and the proportion of the number of moles of the metal ions having a valence of zero is 20 to 50%, the proportion of the number of moles of the metal ions having a valence of 2 is 20 to 50%, while the proportion of the number of moles of the metal ions having a valence of 4 is 10 to 50%.

8. The fuel cell according to claim 1, wherein the particle size of said metal clusters is 160 Å or less.

9. The fuel cell according to claim 8, wherein said metal clusters form secondary particles comprising aggregates in which a plurality of metal clusters are in contact with each other, and the particle size of said secondary particles is 500 to 5000 Å.

10. The fuel cell according to claim 8, wherein the particle size of said support is in the range of 200 Å to 1000 Å.

11. The fuel cell according to claim 1, wherein the amount of electricity per weight of the metal in the metal clusters, as calculated from the hydrogen desorption wave measured by cyclic voltammetry, is 18 coulomb or larger.

12. The fuel cell according to claim 1, wherein said metal clusters contain at least any one of gold, tungsten, copper, cobalt, nickel, iron, manganese, palladium, rhenium, male aluminium, iridium, rhodium, ruthenium and platinum.

13. The fuel cell according to claim 3, wherein the weight of palladium in said electrode catalyst is 5% to 50%.

14. A fuel cell comprising an anode electrode for oxidizing fuel, a cathode electrode for reducing oxygen, an electrolyte membrane for transmitting hydrogen ions, the electrolyte membrane being disposed between the two electrodes, and an electrode catalyst used in at least any one of said anode electrode and said cathode electrode,
wherein said electrode catalyst comprises metal clusters, and said metal clusters are supported on said electrode membrane.

15. A membrane electrode assembly comprising an anode electrode for oxidizing fuel, a cathode electrode for reducing oxygen, an electrolyte membrane for transmitting hydrogen ions, the electrolyte membrane being disposed between the two electrodes, and an electrode catalyst used in at least any one of said anode electrode and said cathode electrode,
wherein said electrode catalyst contains metal clusters.

16. The membrane electrode assembly according to claim 15, wherein said metal clusters comprise a metal species having a valence of zero and a metal species having a valence of 2 or greater.

17. The membrane electrode assembly according to claim 16, wherein said metal clusters have metal ions having valences of zero, 2 and 4, and the proportion of the number of moles of the metal ions having a valence of zero is 20 to 50%, the proportion of the number of moles of the metal ions having a valence of 2 is 20 to 50%, while the proportion of the number of moles of the metal ions having a valence of 4 is 10 to 50%.

18. A portable electronic device driven by a fuel cell, the device being mounted with the fuel cell of claim 1.

19. A portable electronic device mounted with a fuel cell system having a function of generating electricity from a fuel gas using a fuel cell, and a function of supplying hot water while generating electricity,
wherein said device being mounted with the fuel cell of claim 1.

20. The fuel cell according to claim 1, wherein said metal clusters contain species of a metal having different valences, as found in a quantitative analysis by X-ray photoelectron spectroscopy measurement.

21. The membrane electrode assembly according to claim 15, wherein said metal clusters contain species of a metal having different valences, as found in a quantitative analysis by X-ray photoelectron spectroscopy measurement.
